(19) United States
(12) Patent Application Publication
(10) Pub. No.: US 2014/0347901 A1
(43) Pub. Date: Nov. 27, 2014

(54) RECTIFIER CIRCUIT AND POWER SUPPLY INCLUDING THE SAME

(71) Applicant: SAMSUNG ELECTRO-MECHANICS CO., LTD., Suwon (KR)

(72) Inventors: Jae Kook KIM, Suwon (KR); Chong Eun KIM, Suwon (KR)

(73) Assignee: SAMSUNG ELECTRO-MECHANICS CO., LTD., Suwon (KR)

(21) Appl. No.: 13/955,543

(22) Filed: Jul. 31, 2013

(30) Foreign Application Priority Data
May 21, 2013 (KR) 10-2013-0057341

(51) Int. Cl. H02M 7/217

(52) U.S. Cl. CPC H02M 7/2176
USPC 363/126

(57) ABSTRACT

There is provided a rectifier circuit, including a rectifying unit rectifying input power to output rectified power corresponding to a magnitude of the input power and including a plurality of rectifier diodes, a first capacitor connected in parallel to any one of the plurality of rectifier diodes, a switch element connected to the first capacitor in series and controlling energy accumulation or discharge of the first capacitor according to a switching operation, and a controlling unit controlling the switch element based on the magnitude of the input power.

### CROSS-REFERENCE TO RELATED APPLICATIONS

This application claims the priority of Korean Patent Application No. 10-2013-0057341 filed on May 21, 2013, in the Korean Intellectual Property Office, the disclosure of which is incorporated herein by reference.

### BACKGROUND OF THE INVENTION

1. Field of the Invention

The present invention relates to a power supply, and more particularly, to a rectifier circuit in which efficiency is not decreased even at a relatively low input power, and a power supply including the same.

2. Description of the Related Art

In domestic electronic devices such as televisions, notebook computers, and the like, a low power converter including a flyback converter is widely used. Particularly, since an electronic device requiring 75 watts of power or less does not require a power factor corrector (PFC), it outputs input alternating current (AC) as a first direct current (DC) power through only using a rectifier and a smoothing capacitor, and the first DC power is finally output by a DC to DC converter as a second DC power.

Meanwhile, in a case of a universal input in which a peak voltage value is set from 90 volts to 264 volts, a magnitude of a rectified DC voltage is changed about from 127 volts to 373 volts, except for a ripple voltage. In this case, when the magnitude of the DC voltage is low, the DC to DC converter has high current stress caused by the low voltage. The current stress increases heating of a power supply, thereby generally decreasing efficiency of the power supply.

The Patent Document provided as the following related art document, relates to a circuit for preventing a reverse current of a DC to DC converter and does not disclose a technical feature according to the present invention for adjusting a magnitude of an input side DC power of the DC to DC converter based on a magnitude of input power.

### RELATED ART DOCUMENT

(Patent Document 1) Japanese Patent Laid-Open Publication No. 2006-230066

### SUMMARY OF THE INVENTION

An aspect of the present invention provides a rectifier circuit capable of preventing heating of a power supply and increasing efficiency of the power supply by increasing a voltage of direct current (DC) power output from the rectifier circuit when power having a significantly low voltage in a universal input is input, and a power supply including the same.

According to an aspect of the present invention, there is provided a rectifier circuit, including: a rectifying unit rectifying input power to output rectified power corresponding to a magnitude of the input power and including a plurality of rectifier diodes; a first capacitor connected in parallel to any one of the plurality of rectifier diodes; a switch element connected to the first capacitor in series and controlling energy accumulation or discharge of the first capacitor according to a switching operation; and a controlling unit controlling the switch element based on the magnitude of the input power.

The controlling unit may include: a peak detector obtaining a peak voltage of the input power; and a comparator controlling the switching operation of the switch element based on the peak voltage received from the peak detector and a preset reference voltage.

The comparator may turn off the switch element when an absolute value of the peak voltage is greater than the reference voltage, and turn on the switch element when the absolute value of the peak voltage is lower than the reference voltage.

The rectifying unit may be a bridge rectifier.

The switch may be a metal-oxide semiconductor field-effect-transistor (MOSFET) switch.

According to another aspect of the present invention, there is provided a power supply, including: a rectifier circuit rectifying input power; a second capacitor connected to the rectifier circuit in parallel and smoothing an output of the rectifier circuit; and a direct current (DC) to DC converter including a primary winding receiving power smoothed by the second capacitor and a secondary winding electromagnetically connected to the primary winding to supply the power to a load, wherein the rectifier circuit includes: a rectifying unit rectifying input power to output rectified power corresponding to a magnitude of the input power and including a plurality of rectifier diodes; a first capacitor connected in parallel to any one of the plurality of rectifier diodes; a switch element connected to the first capacitor in series and controlling energy accumulation or discharge of the first capacitor according to a switching operation; and a controlling unit controlling the switch element based on the magnitude of the input power.

The power supply may further include an electromagnetic interference (EMI) filter receiving the input power and removing high frequency noise included in the input power, wherein the rectifier circuit receives and rectifies an output of the EMI filter.

The power supply may further include a third capacitor connected to the secondary winding in parallel.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram showing a power supply according to an embodiment of the present invention;

FIG. 2A is an equivalent circuit diagram of FIG. 1 in a case in which an absolute value of a peak voltage of alternating current input power is greater than a reference voltage;

FIG. 2B is an equivalent circuit diagram of FIG. 1 in a case in which the absolute value of the peak voltage of the alternating current input power is lower than the reference voltage and has a positive value;

FIG. 2C is an equivalent circuit diagram of FIG. 1 in a case in which the absolute value of the peak value of the alternating current input power is lower than the reference voltage and has a negative value;

FIG. 3A is a diagram showing waveforms of the respective units of FIG. 1, in the case in which the absolute value of the peak voltage of the alternating current input power is greater than the reference voltage;

FIG. 3B is a diagram showing waveforms of respective units of FIG. 1, in the case in which the absolute value of the peak voltage of the alternating current input power is lower than the reference voltage; and

FIG. 4 is a graph for comparing efficiency according to the embodiment of the present invention with efficiency according to the related art.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

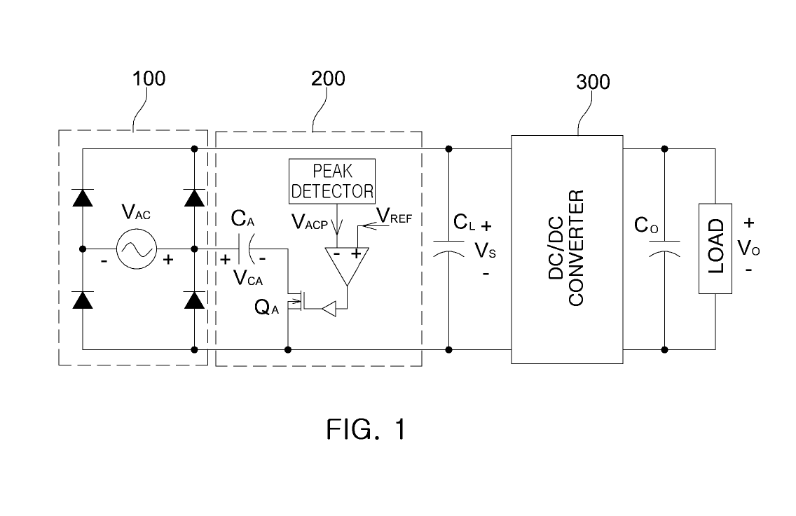

Hereinafter, a configuration of a power supply according to an embodiment of the present invention will be described in detail with reference to FIG. 1.

FIG. 1 is a diagram showing a power supply according to an embodiment of the present invention. As shown in FIG. 1, the power supply according to the embodiment of the present invention include rectifier circuits 100 and 200 and a direct current (DC) to DC converter 300.

The rectifier circuits 100 and 200 may rectify power input to an alternating current input power source V_{AC} and transfer the rectified power to a second capacitor C_{L} which is a smoothing capacitor. Particularly, an electromagnetic interference (EMI) filter for removing high frequency noise included in the power of the alternating current input power source V_{AC} may be disposed between the alternating current input power source V_{AC} and the rectifier circuits 100 and 200.

The DC to DC converter 300 includes a primary winding receiving the power smoothed by the second capacitor C_{L} and a secondary winding coupled to the primary winding to thereby supply the power to a load. Through the DC to DC converter 300, a desired output voltage V_{O} may be obtained. Particularly, in order to obtain a stabilized output voltage V_{O}, the secondary winding may be connected to a third capacitor V_{O} in parallel. Further, as an example of the DC to DC converter 300 in the power supply according to the embodiment of the present invention, an insulating converter such as a flyback converter, a forward converter, or the like may be used.

Specifically, the rectifier circuits 100 and 200 according to the embodiment of the present invention may include a rectifying unit 100, a first capacitor C_{A}, a switch element Q_{A}, and a controlling unit 200.

The rectifying unit 100 may output the rectified power corresponding to a magnitude of the power input to the alternating current input power source V_{AC} and include a plurality of rectifier diodes, as shown in FIG. 1. In addition, as the rectifying unit, a full-wave rectifier may be used, rather than using a half-wave rectifier, and the rectifying unit may include a bridge rectifier.

The first capacitor C_{A} may be connected in parallel to one of the plurality of rectifier diodes, and the switch element Q_{A} may be connected in series to the first capacitor C_{A} in order to control energy accumulation or discharge of the first capacitor C_{A}. As the switch element Q_{A}, a metal-oxide semiconductor field-effect-transistor (MOSFET) switch having a small volume and a high switching speed may be used rather than using a relay switch having a large volume and a low switching speed.

A switching operation of the switch element Q_{A} is controlled by the controlling unit 200 including a peak detector and a comparator. The peak detector may detect a peak voltage of the alternating current input power source V_{AC}. The comparator controls the switching operation of the switch element Q_{A} based on a peak voltage V_{ACP} detected by the peak detector and a preset reference voltage V_{REF}.

The comparator in a power supply circuit according to an embodiment of the present invention may turn off the switch element Q_{A} when an absolute value of the peak voltage V_{ACP} is greater than the reference voltage V_{REF}, and may turn on the switch element Q_{A} when the absolute value of the peak voltage V_{ACP} is lower than the reference voltage V_{REF}.

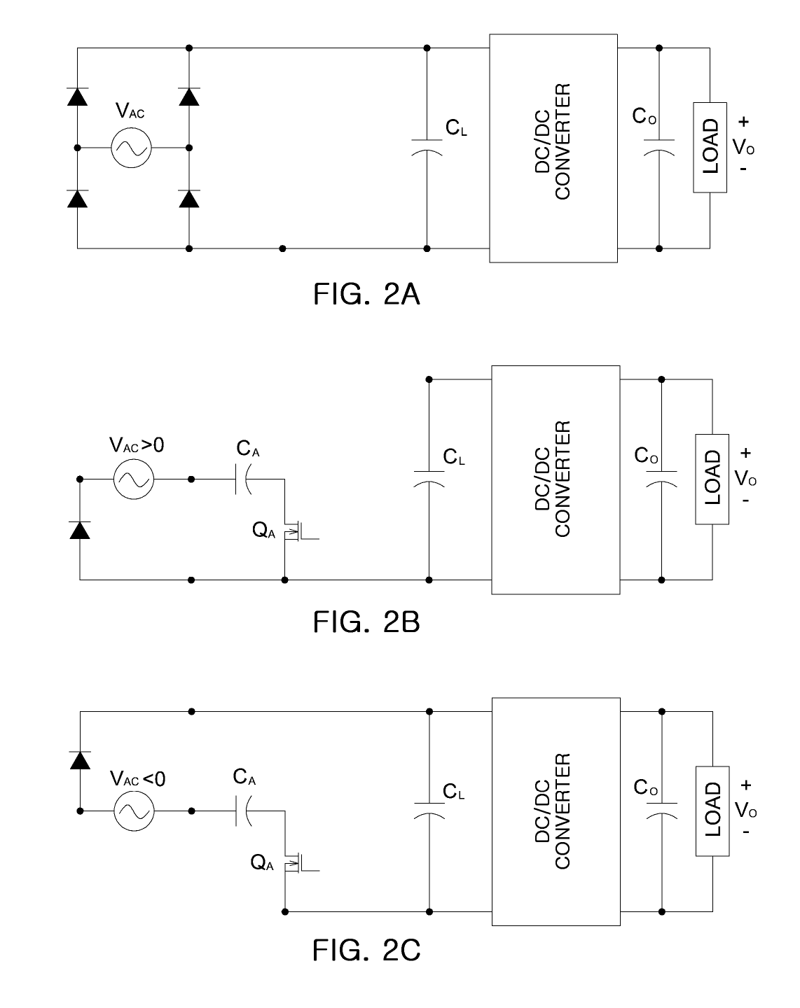

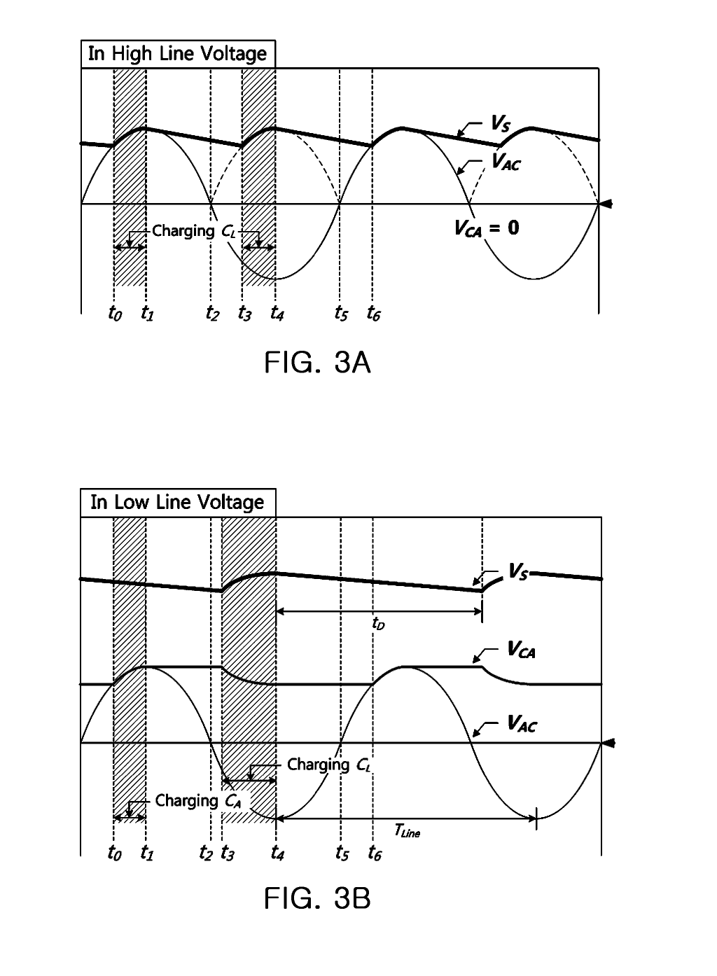

Hereinafter, operations of the power supply according to the present invention in response to magnitudes of input power will be described with reference to FIGS. 2 and 3.

FIG. 2A is an equivalent circuit diagram of FIG. 1 in the case in which the absolute value of the peak voltage V_{ACP} is greater than the reference voltage V_{REF} and FIG. 3A is a diagram showing voltage waveforms for main nodes in a circuit of FIG. 1 in the case in which the absolute value of the peak voltage V_{ACP} is greater than the reference voltage V_{REF}.

As described above, in the case in which the absolute value of the peak voltage V_{ACP} of the alternating current input power source V_{AC} detected by the peak detector is greater than the reference voltage V_{REF}, the switch element Q_{A} is turned off. In this case, since power input to the first capacitor C_{A} is blocked, the first capacitor C_{A} does not influence on the circuit. As a result, an equivalent circuit as shown in FIG. 2A may be configured. In this case, as shown in FIG. 3A, a voltage V_{CA} across the first capacitor C_{A} becomes zero voltage and a voltage V_{S} across the second capacitor C_{L} that smoothes the output of the rectifier circuit may affected only by a voltage of the alternating current input power source V_{AC}. Specifically, the second capacitor C_{L} is charged with energy from the alternating current input power source V_{AC} in an interval of t₀ to t₁ and discharges the energy in an interval t₁ to t₃, in FIG. 3A.

On the contrary, operations of the power supply in the case in which the absolute value of the peak voltage V_{ACP} is lower than the reference voltage V_{REF} will be described with reference to FIGS. 2B, 2C, and 3B.

FIG. 2B is an equivalent circuit diagram of FIG. 1 in the case in which the absolute value of the peak voltage V_{ACP} is lower than the reference voltage V_{REF}, and the voltage of the alternating current input power source V_{AC} is greater than 0. FIG. 2C is an equivalent circuit diagram of FIG. 1 in the case in which the absolute value of the peak voltage V_{ACP} is lower than the reference voltage V_{REF}, and the voltage of the alternating current input power source V_{AC} is less than 0. In addition, FIG. 3B is a diagram showing voltage waveforms for main nodes in the circuit of FIG. 1 in the case in which the absolute value of the peak voltage V_{ACP} is lower than the reference voltage V_{REF}.

In the case in which the absolute value of the peak voltage V_{ACP} is lower than the reference voltage V_{REF}, since the switch element Q_{A} is switched on, as shown in FIGS. 2B and 2C, the second capacitor C_{A} influences on a power supply device. Specifically, in the case in which the voltage of the alternating current input power source V_{AC} is greater than 0, as shown in FIG. 2B, an energy transfer path is formed between the alternating current input power source V_{AC} and the first capacitor C_{A}, and an energy transfer path from the alternating current input power source V_{AC} to the second capacitor C_{L} may be blocked. In this case, similarly to the interval t₀ to t₁ of FIG. 3B, an interval in which the first capacitor C_{A} is charged with energy may be present and the energy charged in the second capacitor C_{L} may be discharged. In the case in which the voltage of the alternating current input power source V_{AC} is less than 0, as shown in FIG. 2C, the alternating current input power source V_{AC} does not transfer the energy to the first capacitor C_{A} by the diode and the second capacitor C_{L} may receive the energy from the alternating current input power source V_{AC}. In this case, the energy charged in the first capacitor C_{A} is discharged, and similarly to the interval t₃ to t₄ of FIG. 3B, an interval in which the second capacitor C_{L} is charged with energy may be present.

As describe above, in the case in which the absolute value of the peak voltage V_{ACP} of the alternating current input power source V_{AC} is lower than the reference voltage V_{REF}, the switch element Q_{A} is switched on. Here, in the case in which the alternating current input power source V_{AC} is in a positive cycle, the first capacitor C_{A} may be charged, and in the case in which the alternating current input power source V_{AC} is in a negative cycle, the second capacitor C_{A} may be charged. Meanwhile, in this case, the voltage V_{S} across the primary winding, an input side of the DC to DC converter 300 may be a sum of the voltage across the first capacitor C_{A} and the voltage across the second capacitor C_{L}.

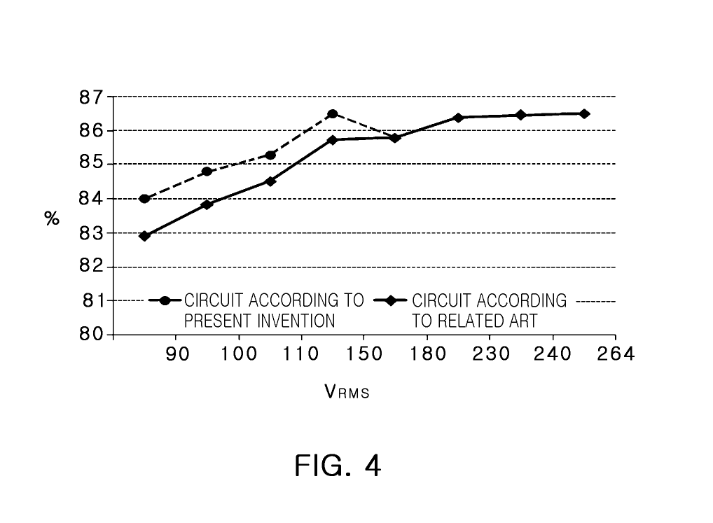

FIG. 4 is a graph for comparing efficiency according to the embodiment of the present invention with efficiency according to the related art. A vertical axis of the graph shown in FIG. 4 shows efficiency of the power supply device and a horizontal axis thereof shows an RMS value of the alternating current input power.

As described above, in the case in which the absolute value of the peak voltage V_{ACP} of the alternating current input power source V_{AC} is greater than the reference voltage V_{REF}, the voltage V_{S} of the input side of the DC to DC converter 300 corresponds to the voltage across the second capacitor C_{L}. On the other hand, in the case in which the absolute value of the peak voltage V_{ACP} of the alternating current input power source V_{AC} is lower than the reference voltage V_{REF}, the voltage V_{S} of the input side of the DC to DC converter 300 corresponds to the sum of the voltage across the first capacitor C_{A} and the voltage across the second capacitor C_{L}. Therefore, high current stress in the power supply device caused by a low input power may be prevented, such that heating of the power supply device may be decreased to thereby improve efficiency thereof.

As shown in FIG. 4, comparing the power supply device according to the embodiment of the present invention with a supply device according to the related art, in a region in which the alternating current input power is 180V_{RMS} or more, there is no difference between efficiencies of both inventions. On the other hand, it may be confirmed that the power supply device according to the embodiment of the present invention has improved efficiency as compared to the efficiency of the supply device according to the related art.

As set forth above, in a rectifier circuit and a power supply including the same according to embodiments of the present invention, one of a plurality of diodes included in the rectifying unit is connected to a capacitor in parallel, and charging and discharging of the capacitor are controlled by a switch element connected to the capacitor in series, such that current stress of a converter can be prevented by increasing rectified DC voltage even in a case in which a low input voltage is applied.

Further, heating of the power supply can be decreased, such that efficiency of the power supply can be increased.

While the present invention has been shown and described in connection with the embodiments, it will be apparent to those skilled in the art that modifications and variations can be made without departing from the spirit and scope of the invention as defined by the appended claims.

What is claimed is:

1. A rectifier circuit, comprising:
a rectifying unit rectifying input power to output rectified power corresponding to a magnitude of the input power and including a plurality of rectifier diodes;
a first capacitor connected in parallel to any one of the plurality of rectifier diodes;
a switch element connected to the first capacitor in series and controlling energy accumulation or discharge of the first capacitor according to a switching operation; and
a controlling unit controlling the switch element based on the magnitude of the input power.

2. The rectifier circuit of claim 1, wherein the controlling unit includes:
a peak detector obtaining a peak voltage of the input power; and
a comparator controlling the switching operation of the switch element based on the peak voltage received from the peak detector and a preset reference voltage.

3. The rectifier circuit of claim 2, wherein the comparator turns off the switch element when an absolute value of the peak voltage is greater than the reference voltage, and turns on the switch element when the absolute value of the peak voltage is lower than the reference voltage.

4. The rectifier circuit of claim 1, wherein the rectifying unit is a bridge rectifier.

5. The rectifier circuit of claim 1, wherein the switch element is a metal-oxide semiconductor field-effect-transistor (MOSFET) switch.

6. A power supply, comprising:
a rectifier circuit rectifying input power;
a second capacitor connected to the rectifier circuit in parallel and smoothing an output of the rectifier circuit; and
a direct current (DC) to DC converter including a primary winding receiving power smoothed by the second capacitor and a secondary winding electromagnetically connected to the primary winding to supply the power to a load,
wherein the rectifier circuit includes:
a rectifying unit rectifying input power to output rectified power corresponding to a magnitude of the input power and including a plurality of rectifier diodes;
a first capacitor connected in parallel to any one of the plurality of rectifier diodes;
a switch element connected to the first capacitor in series and controlling energy accumulation or discharge of the first capacitor according to a switching operation; and
a controlling unit controlling the switch element based on the magnitude of the input power.

7. The power supply of claim 6, wherein the controlling unit includes:
a peak detector obtaining a peak voltage of the input power; and
a comparator controlling the switching operation of the switch element based on the peak voltage received from the peak detector and a preset reference voltage.

8. The power supply of claim 7, wherein the comparator turns off the switch element when an absolute value of the peak voltage is greater than the reference voltage, and turns on the switch element when the absolute value of the peak voltage is lower than the reference voltage.

9. The power supply of claim 6, wherein the rectifying unit is a bridge rectifier.

10. The power supply of claim 6, wherein the switch element is a metal-oxide semiconductor field-effect-transistor (MOSFET) switch.

11. The power supply of claim 6, further comprising an electromagnetic interference (EMI) filter receiving the input power and removing high frequency noise included in the input power,
wherein the rectifier circuit receives and rectifies an output of the EMI filter.

12. The power supply of claim 6, further comprising a third capacitor connected to the secondary winding in parallel.
